(19) United States
(12) Patent Application Publication
(10) Pub. No.: US 2019/0324398 A1
(43) Pub. Date: Oct. 24, 2019

(54) MECHANICAL OSCILLATOR

(71) Applicant: ECOLE POLYTECHNIQUE FÉDÉRALE DE LAUSANNE (EPFL), Lausanne (CH)

(72) Inventors: Mohammad Hussein KAHROBAIYAN, Neuchâtel (CH); Ilan VARDI, Neuchâtel (CH); Simon HENEIN, Neuchâtel (CH)

(73) Assignee: ECOLE POLYTECHNIQUE FÉDÉRALE DE LAUSANNE (EPFL), Lausanne (CH)

(21) Appl. No.: 16/467,530

(22) PCT Filed: Dec. 20, 2017
(86) PCT No.: PCT/EP2017/083776

§ 371 Date: Jun. 7, 2019

(30) Foreign Application Priority Data
Dec. 20, 2016 (EP) 16205254.2

(51) Int. Cl. G04B 17/04; G04B 17/28

(52) U.S. Cl. CPC G04B 17/04; G04B 17/28

(57) ABSTRACT

Mechanical oscillator comprising:
an inertial body having a primary moment of inertia I about a first (y) and second (z) orthogonal axes, and a secondary moment of inertia J about a third axis (x, P) orthogonal to each of said first (y) and second (z) axes; and
an elastic system arranged to apply a restoring torque τ to said inertial body, said restoring torque τ acting to urge said inertial body towards a resting position, said elastic system being arranged such that said inertial body has substantially two degrees of freedom in rotation, one of said degrees of freedom being around said first axis (y) and another of said degrees of freedom being around said second axis (z), and substantially zero degrees of freedom in translation

According to the invention, the ratio of secondary moment of inertia J to primary moment of inertia/substantially obeys the equation:

$$\frac{J}{I} = \frac{2 {k}_{3}}{{k}_{1}} + 4 / 3$$

and said restoring torque r substantially obeys the equation:

τ(θ)=k₁θ+k₃θ³+k₅θ⁵+ . . .

wherein k₁, k₃, k₅ . . . are constants and θ is an angle of inclination of said third axis (x, P) of said inertial body with respect to a direction of said third axis (xᵣ) when said inertial body is in said resting position.

### TECHNICAL FIELD

The present invention relates to the field of mechanical oscillators. More specifically, it relates to a two degree-of-freedom (DOF) mechanical oscillator intended for use as a timebase in a timepiece without an intermittent escapement.

### State of the Art

EP2894521, in the name of the present applicant, describes two degree-of-freedom (DOF) oscillators which could advantageously replace 1-DOF oscillator time bases such as pendulums and balance-hairspring oscillators, since their unidirectional oscillations can be maintained and counted without an escapement. Horological escapements are well-known to be inefficient due to their reliance on impacts between escapement wheel teeth and pallet-stones (or similar), since their discretization of time produces stop and go motion of the drive train resulting in energy losses such as audible ticking. On the other hand, 2-DOF oscillators can produce unidirectional trajectories which can be maintained by a simple crank mechanism, as described in the above-mentioned document, resulting in continuous motion which is much more efficient. 2-DOF oscillators producing unidirectional trajectories are known as IsoSpring, see the publication S. Henein, I. Vardi, L. Rubbert, R. Bitteril, N. Ferrier, S. Fifanski, D. Lengacher, IsoSpring: vers la montre sans échappement, actes de la Journée d'Etude de la SSC 2014, 49-58.

In order to be an acceptable timebase, an oscillator should be isochronous, and the conditions for this were first described by Isaac Newton in his Principia Mathematica, Book I, Proposition X: There must be a central isotropic linear restoring force, see the above-mentioned references for details.

The first 2-DOF oscillator produced by the applicant was based on XY stages and was described in EP2894521, then analyzed scientifically in the paper L. Rubbert, R. A. Bitterli, N. Ferrier, S. K. Fifanski, I. Vardi and S. Henein, Isotropic springs based on parallel flexure stages, Precision Engineering 43 (2016), 132-145. This is a translational oscillator, as the mass undergoes pure translation.

This oscillator has the disadvantage that its functionality is affected by a change of orientation with respect to gravity.

WO2015104693, also in the name of the present applicant, 2-DOF purely rotational oscillators are described, by which is meant that oscillatory motion comprises a single mass rotating around a fixed point, generally taken to be its center of gravity, and limited to two degrees of freedom in rotation only (i.e. without a degree of freedom in translation). For small tilt angles θ defined below, this oscillator also produces unidirectional trajectories, so it can be used as a time base without escapement. It less sensitive to its orientation with respect to gravity so has advantages over XY stages realizations. However, Newton's model requires planar trajectories, which is not the case for these oscillators, so isochronism cannot hold.

In this latter document, rotational oscillators having a spherical mass are considered. If isochronism is limited to constant speed circular motion, which is called circular isochronism, then there is one particular restoring torque, which we call the scissors law, producing perfect circular isochronism. Specific realizations are disclosed in this document; however, these are still sensitive to a change of orientation with respect to gravity.

Other rotational oscillators are also disclosed in the document FR630831.

An aim of the present invention is hence to propose a 2-DOF mechanical oscillator which is less sensitive to the direction of the gravity vector

### SUMMARY OF THE INVENTION

In the present specification, all units are SI base units, SI supplementary units or SI derived units unless otherwise explicitly stated. In particular, it is noted that angles are in the SI derived unit radians, unless degrees (°) are explicitly indicated.

To this end, the invention relates to mechanical oscillator, for instance for use in a timekeeper, comprising an inertial body having a primary moment of inertia I about a first and second orthogonal axes, and a secondary moment of inertia J about a third axis orthogonal to each of said first and second axes.

An elastic system is provided, which is arranged to apply a restoring torque τ to said inertial body, said restoring torque acting to urge said inertial body towards a resting position.

The elastic system is arranged and adapted such that the inertial body has substantially two degrees of freedom in rotation, one of said degrees of freedom being around said first axis and another of said degrees of freedom being around said second axis, and substantially zero degrees of freedom in translation or around said third axis.

According to the invention, the ratio of secondary moment of inertia J to primary moment of inertia/substantially obeys the equation:

$$\frac{J}{I} = \frac{2 {k}_{3}}{{k}_{1}} + 4 / 3$$

and said restoring torque substantially obeys the equation:

τ(θ)=k₁θ+k₃θ³+k₅θ⁵+ . . .

wherein k₁, k₃, k₅ . . . are constants and θ is an angle of inclination of said third axis of said inertial body with respect to a direction of said third axis when said inertial body is in said resting position, i.e. with respect to a fixed frame of reference anchored on the resting orientation of the inertial body. θ is by definition expressed in radians as mentioned above.

It has been found that once these conditions have been fulfilled, circular isochronism (as defined below) is significantly improved and the oscillator is significantly less sensitive to gravity that that described in the above-mentioned prior art. Since this condition is based on a ratio of inertias, it is clear that an infinite number of different geometries will fulfil it, examples of which are detailed below.

As a first-order approximation, the ratio of secondary moment of inertia J to primary moment of inertia I can substantially obey the equation:

$$\frac{J}{I} = 4 / 3$$

and the restoring torque can substantially obey the equation:

τ(θ)=k₁θ

This approximation, in which the restoring torque is linear, simplifies calculation and the conception of the mechanical oscillator, while still providing sufficient practical circular isochronism. In general, an acceptable approximation of θ (i.e. its tolerance) satisfies:

$$\vert \frac{τ ( θ ) - {k}_{1} θ}{{k}_{1} θ} \vert \leq 10 ppm$$

The inertial body may be shaped as a prism, a cylinder, a pyramid, a cone, a body of revolution, or any other convenient shape.

Advantageously, the elastic system comprises a plurality of elastic articulations, which provide a good suspension of the inertial body without friction-inducing joints, bearings and so on. This improves the quality factor Q of the oscillator by providing lower mechanical resistance to oscillation, and eliminating conventional bearings.

Advantageously, the inertial body comprises at least five adjustable inertial blocks arranged so as to adjust said primary moment of inertia I and said secondary moment of inertia J. These inertial blocks may be small tuning elements such as screws, having a relatively small inertia with respect to the main part of the inertial body, or may give rise to a significant proportion of the inertia of the inertial body when considered as a whole.

Advantageously, two of said adjustable inertial blocks are situated along said third axis and are adjustable along said third axis, and wherein at least three of said adjustable inertial blocks are evenly angularly spaced around said inertial body and are situated in a plane parallel to and/or defined by said first axis and said second axis, these latter adjustable inertial blocks being adjustable radially with respect to said inertial body. This arrangement permits easy tuning of the primary moment of inertia I and the secondary moment of inertia J to better fulfil one of the conditions mentioned above.

Alternatively, the adjustable inertial blocks, which may e.g. be screws, can be arranged as a first set of inertial blocks arranged in a first half of said inertial body situated on a first side of a plane perpendicular to said third axis and a second set of inertial blocks arranged in a second half of said inertial body situated on another side of said plane, wherein each of said sets of inertial blocks comprises at least three inertial blocks distributed evenly around said third axis in a conical configuration, each inertial body being displaceable along an axis intersecting said third axis. Each inertial block of each set may be directly facing a corresponding block of the other set along an axis parallel to said third axis, or may be angularly offset therefrom, e.g. facing a midpoint between two adjacent blocks.

In this latter variant, the axes along which the inertial blocks of said first set intersect said third axis at a first point situated further from the center of gravity of the inertial body than a plane comprising said first set of inertial blocks, and the axes of displacement of the inertial blocks of said second set intersect said third axis at a second point situated further from the center of gravity of the inertial body than a plane comprising said second set of inertial blocks. In layman's terms, if the inertial blocks are screws, their stems point outwards, away from the center of gravity of the inertial body. This alternative configuration also permits easy adjustment of the primary and secondary moments of inertia of the inertial body so as to better fulfil the conditions mentioned above.

In an alternative arrangement, the inertial body may comprise a disk mounted on at least one rod extending along said third axis, which support at least three equatorial inertial blocks. Furthermore, said rod may support a pair of polar inertial blocks, one of said polar inertial blocks being situated on each side of said disk. In order to permit easy adjustment of the equatorial inertial blocks, these latter may be supported in a spiral groove provided in the disk. Rotating the disk with respect to the equatorial inertial blocks, e.g. by causing them to move along the spiral groove, enables very fine adjustment of the moments of inertia I and J.

In yet another alternative arrangement, the inertial body may comprise a set of first rods comprising at least one polar rod extending along said third axis, and at least three equatorial rods extending from said polar rod in a plane perpendicular to said third axis, said at least one polar rod supporting a pair of polar inertial blocks, one situated on each side of said plane, and each of said equatorial rods supporting an equatorial inertial block, at least some of said inertial blocks being movably mounted upon their respective rods. This set of rods acts as a frame upon which the inertial blocks are supported. Adjusting the position of the various inertial blocks on their respective rods permits easy adjustment of the primary and secondary moments of inertia.

Advantageously, each equatorial inertial block is linked to each polar inertial block by means of an oblique rod, which may be joined to its respective inertial blocks by means of a ball joint. The movement of the various inertial blocks is hence linked, reducing the number of degrees of freedom of adjustment and hence making it simpler to carry out.

In yet another alternative arrangement, the inertial body comprises at least three elastically deformable elements.

In one variant comprising three elastically deformable elements, the inertial body comprises a rod situated along said third axis with said at least three elastically deformable elements evenly distributed therearound. The elastically deformable elements are joined together at each extremity, e.g. by means of a respective hub at each end, said extremities being displaceable so as to vary the form of said elastically deformable elements, and hence the primary and secondary moments of inertia I and J. This displacement may for instance be parallel to the rod or away from the rod, in a direction principally perpendicular thereto.

In a variant in which the extremities of said elastically deformable elements are displaceable along said rod, this displacement may be by means of at least one nut provided on said rod. This arrangement is particularly simple, and by “squeezing” the extremities of the elastically deformable elements together, they can be caused to adopt a shorter and fatter configuration, and by allowing them to separate results in a longer and thinner arrangement, thereby permitting variation of the primary and secondary moments of inertia by simply adjusting the nuts.

Alternatively, the elastically deformable elements can be slidably attached to said rod at an intermediate point of said elastically deformable elements, e.g. by means of a hub attached at their midpoints. The extremities of said elastically deformable elements can then be displaced away from, i.e. substantially perpendicular to (with the exception of a small axial component), the rod by means of a pair of wedges interposed between said elastically deformable elements, one wedge being situated proximate to each end thereof. By moving the wedges towards the midpoints of the elastically-deformable elements, their extremities are splayed out, thereby altering the primary and secondary moments of inertia. It should be noted that since the elastically-deformable elements deform in bending, there is a relatively small component of motion of their tips parallel to the rod. However, this can largely be discounted.

### BRIEF DESCRIPTION OF THE DRAWINGS

The invention will now be described in detail in reference to the appended figures, which illustrate:

FIG. 1: a schematic representation of the general case of an inertial body for use in a mechanical oscillator;

FIG. 2: a schematic representation of a prismatic variant of an inertial body for use in a mechanical oscillator;

FIG. 3: a schematic representation of a general case of an inertial body with tunable inertias for use in a mechanical oscillator;

FIG. 4: a schematic representation of a prismatic variant an inertial body with tunable inertias for use in a mechanical oscillator;

FIG. 5: a schematic representation of a prismatic variant of an inertial body with a specific geometry for use in a mechanical;

FIG. 6: a schematic representation of a hollow prismatic variant of an inertial body with a specific geometry for use in a mechanical oscillator;

FIG. 7: a schematic representation of a general prismatic variant of an inertial body with a specific geometry for use in a mechanical oscillator;

FIG. 8: a schematic representation of a conical variant of an inertial body with a specific geometry for use in a mechanical oscillator;

FIG. 9: a schematic representation of a general conical variant of an inertial body with a specific geometry for use in a mechanical oscillator;

FIG. 10: a schematic representation of an ellipsoidal variant of an inertial body with a specific geometry for use in a mechanical oscillator;

FIG. 11: a schematic representation of a hollow ellipsoidal variant of an inertial body with a specific geometry for use in a mechanical oscillator;

FIG. 12: a schematic representation of a variant of an inertial body shaped as a body of revolution formed by a sphere cut by a cylinder, with a specific geometry for use in a mechanical oscillator;

FIG. 13: a schematic representation of two variant of inertial bodies formed as bodies of revolution of circular arcs, with a specific geometry for use in a mechanical oscillator;

FIG. 14: a schematic representation of variant of an inertial body formed as a general body of revolution, with a specific geometry, for use in a mechanical oscillator;

FIG. 15: a schematic representation of a cylindrical variant of an inertial body with a specific geometry and provided with a five-screw adjustment system, for use in a mechanical oscillator;

FIG. 16: a schematic representation of a cylindrical variant of an inertial body with a specific geometry and provided with a six-screw adjustment system, for use in a mechanical oscillator;

FIG. 17: a schematic representation of a particular variant of an inertial body comprising a disk and a five inertial block adjustment system, for use in a mechanical oscillator;

FIG. 18: a schematic representation of a particular variant of an inertial body comprising five inertial blocks linked by rods, for use in a mechanical oscillator;

FIG. 19: a schematic representation of a particular variant of an inertial body comprising an adjustable flexure mechanism, for use in a mechanical oscillator;

FIG. 20: a schematic representation of a particular variant of an inertial body comprising a flexure and adjustable wedge system, for use in a mechanical oscillator; and

FIG. 21: a schematic isometric representation of a mechanical oscillator according to the invention, comprising a generalized inertial body.

### EMBODIMENTS OF THE INVENTION

### Technical Background: General Case of 2-DOF Rotary Motion

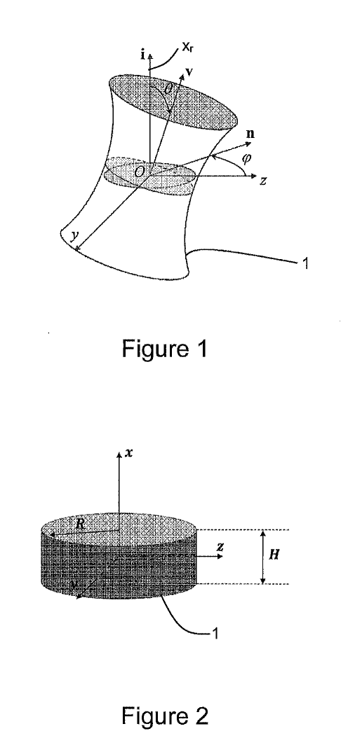

In reference to FIG. 1, consider an inertial body 1 constituting an oscillating mass undergoing pure rotational motion. In order to satisfy the IsoSpring condition, the 3-DOF of pure rotational kinematics must be restricted to 2-DOF. The oscillator of the invention therefore satisfies Listing's Law, a restriction on rotations first formulated for eye movements, see for instance H. von Helmholtz, Helmholtz's Treatise on Physiological Optics, Volume III, The Perceptions of Vision, Edited by James P. C. Southall, Optical Society of America 1925, and R. H. S. Carpenter, Movements of the eyes, 2nd edition, Pion, London 1988.

Listing's Law states that there is a direction called the primary position so that any admissible position is obtained from this position by a rotation whose axis is perpendicular to the direction of the primary position.

As usual, the x, y, z directions are given by the unit vectors i, j, k. The primary position is chosen to be the x direction, in other words, the vector i, and Listing's Law states that all admissible positions are obtained by a rotation around a unit vector n lying in the y, z plane (see FIG. 1). Rotations can also be expressed in terms of two angles θ and φ, where φ is the angle that n has with respect to the z axis in the y, z plane and θ is the rotation angle around n. In other words, the angle θ corresponds the angle between the axis x of the inertial body 1 when displaced with respect to the orientation of this axis x when the inertial body 1 is at rest in a neutral position (also referred to as axis xᵣ) upon which the unit vector i lies, and which forms a fixed frame of reference. One also notes that close to the primary position, θ is similar to radial motion and φ is similar to circular motion.

In terms of the mechanical oscillator of the invention, it is assumed there is a mass whose neutral position corresponds to the primary position, and that it rotates to an admissible Listing position (θ, φ). There is a central restoring force, which means that it is a function of θ only, and this force will be assumed to result from a potential energy V(θ).

Furthermore, in the following it should be noted that the 2-DOF oscillators described herein have substantially two degrees of freedom. While it is impossible to absolutely prevent any movement at all in other degrees of freedom since any structure can be deformed in compression or tension according to Hooke's law, it is considered that a stiffness exceeding 100, preferably 1,000, further preferably 10,000, times the stiffness of at least one of the intended degrees of freedom according to angles θ and φ as described above is substantially rigid and hence does not constitute a degree of freedom in the sense of this patent.

### Dynamics

In order to analyze the behavior of the mechanical oscillator, its equations of motion must be derived. The first step is to derive its kinetic energy which is done by computing its angular velocity. In order to do this, a rotation by angle β around a unit vector u is written as R(β, u) applied to vectors on the right.

Now recall Euler angles which express any rotation by three angles θ, φ, ψ: First, a rotation by φ around i takes k to n, then a rotation by θ around n takes i to v and finally a rotation by ψ around v. This means that any rotation can be written as R(φ, i)R(θ, n)R(ψ, v).

Listing's Law is simply the case ψ=−φ so can be written in terms of Euler angles as R(φ, i)R(θ, n)R(−φ, v).

The angular velocity ω of a Listing rotation can now be derived by the additivity of infinitesimal rotations yielding

ω=\dot{φ}i−\dot{φ}v+θn. (1)

If the mass is a sphere, then its moment of inertia is given by the single scalar I and its kinetic energy is

$$K = \frac{I {‖ ω ‖}^{2}}{2} .$$

Expressing the relations between i, n, v in terms of θ and φ gives

$$K = \frac{I}{2} ( {θ}^{2} + 4 {sin}^{2} ( \frac{θ}{2} ) {\dot{ϕ}}^{2} ) .$$

Given a central potential energy V(θ), the Lagranglan is

$$ℒ = K - V = \frac{I}{2} ( {\dot{θ}}^{2} + 4 {sin}^{2} ( \frac{θ}{2} ) {\dot{ϕ}}^{2} ) - V ( θ ) .$$

The Euler-Lagrange equation in θ is

$$\frac{d}{dt} ( \frac{\partial ℒ}{\partial \dot{θ}} ) = \frac{\partial ℒ}{\partial θ} ,$$

which gives the equation of motion

I\ddot{θ}−I\dot{φ}² sin θ+τ(θ)=0,

where τ(θ) is the restoring torque given by

$$τ ( θ ) = \frac{\partial V}{\partial θ} .$$

### Circular Isochronism

Since true isochronism cannot hold, a restricted form is considered which is named here circular isochronism and limits consideration to periods of steady state circular trajectories, i.e., those with constant θ and constant \dot{φ}. The circular isochronism defect quantifies the discrepancy from perfect circular isochronism. The equation of motion shows that in this case

$$\dot{ϕ} = \sqrt{\frac{τ ( θ )}{I sin θ}}$$

The simplest restoring torque is a linear restoring torque τ(θ)=κθ, with κ constant, so that

$$\dot{ϕ} = \sqrt{\frac{κ θ}{I sin θ}} .$$

Note that ω₀=\sqrt{κ/I} is the classic natural frequency corresponding to a one-dimensional rotational oscillator with stiffness x and moment of inertia I. The period is then T=2π/\dot{φ} and the nominal period T₀=2π/ω₀ is chosen so that up to the second order

$$\frac{T}{{T}_{0}} = 1 - \frac{1}{12} {θ}^{2} ,$$

which gives the circular isochronism defect −θ²/12.

It can be seen that the restoring torque ½κ sin θ gives perfect circular isochronism since the above formula yields

$$\dot{ϕ} = \sqrt{\frac{κ}{2 I}} ,$$

which is independent of θ. The corresponding potential energy V₉=κ sin²(θ/2) is referred to as the scissors potential because the restoring torque ½κ sin θ can be realized by a scissors-like mechanism, as illustrated in FIG. 39 of WO2015104693. In theory, the mechanisms described in the aforementioned document produce perfect circular isochronism.

### Theory of the Invention

A mathematically-perfect implementation of the scissors potential with a spherical mass is difficult to achieve in practice, so in the present invention a different approach is used in which the isochronism defect is minimized for an arbitrary potential by modifying the geometry of the oscillating mass.

### Inertia-Cylindrical Bodies

In essence, the dynamics of an oscillator only depend on the inertia matrix (in general an inertia tensor) of the oscillating mass and not its exact geometry. In particular, given a body with inertia matrix

$$I = [ \begin{matrix}{I}_{x} & 0 & 0 \\ 0 & {I}_{y} & 0 \\ 0 & 0 & {I}_{z}\end{matrix} ] ,$$

with Iₓ the moment of inertia around the x axis, I_{y}, the moment of inertia around the y axis and I_{z} the moment of inertia around the z axis, then the dynamics as described above hold if I=Iₓ=I_{y}=I_{z}, even if the body itself is not a geometric sphere. More generally, it would appear that an oscillator satisfying Listing's Law and having a central restoring potential should have a mass, which, when in the primary position, is a volume of revolution around the primary position i. However, only the moments of inertia matter for the dynamics, so it suffices that its inertia matrix satisfy I=I_{y}=I_{z}. Such a body is referred to here as inertia-cylindrical. Letting J=Iₓ, it can be derived that

$$α = \frac{J}{I}$$

for the aspect ratio of an inertia-cylindrical mass, note that a sphere has α=1.

In the following text, I is referred to as a primary moment of inertia about a first and a second axes, corresponding to axes y and z respectively, and J is referred to as a secondary moment of inertia about a third axis, corresponding to axis x. Axis x also corresponds to the polar axis P of the inertial body 1.

### Dynamics

The dynamics as described above are the same and with the same notation, the angular velocity under Listing's Law is again given by Equation (1) (see above). The only difference is that the moment of inertia is now given by a matrix so that the kinetic energy is

$$K = \frac{1}{2} ω \cdot I ω = \frac{1}{2} [ 4 I {\dot{ϕ}}^{2} {sin}^{2} \frac{θ}{2} ( 1 + ( α - 1 ) {sin}^{2} \frac{θ}{2} ) + I {\dot{θ}}^{2} ] .$$

Assuming a central potential V(θ) not depending on φ, the Euler-Lagrange equation in θ gives the equation of motion

$$\begin{matrix}I \ddot{θ} - I {\dot{ϕ}}^{2} sin θ [ 1 + ( α - 1 ) ( 1 - cos θ ) ] + τ ( θ ) = 0 , \\ where \\ τ ( θ ) = \frac{\partial V}{\partial θ}\end{matrix} \qquad ( 2 )$$

is the restoring torque. Setting θ constant in the equation of motion (2) gives the formula for angular speed of steady state circular orbits

$$\dot{ϕ} = \sqrt{\frac{τ ( θ )}{I sin θ [ 1 + ( α - 1 ) ( 1 - cos θ ) ]}} .$$

### Isochronism Defect for an Arbitrary Central Potential

Given an arbitrary central potential V(θ), the circular isochronism defect can be minimized by modifying the geometry of the oscillating mass. It can be assumed that for small θ the corresponding restoring torque can be written as the power series

τ(θ)=k₁θ+k₃θ³+k₅θ⁵+ . . . , (3)

where only odd powers of θ appear, and in which k₁, k₃, k₅ . . . are constants. This follows from the fact that the restoring torque acts in an opposite direction when θ→−θ, so τ(θ) is an odd function of θ.

Using the power series expansion (3), the formula for steady-state circular orbits as described above and the power series expansions of sin θ and cos θ yields the power series

$$\frac{\dot{ϕ}}{{ω}_{0}} = 1 + \frac{1}{2} [ \frac{{k}_{3}}{{k}_{1}} - ( \frac{α}{2} - \frac{2}{3} ) ] {θ}^{2} + 0 ( {θ}^{4} ) ,$$

where ω0=\sqrt{k₁/I} and O(⋅) is the Landau notation. Once again the period can be written as T=2π/\dot{φ} and the nominal period can be chosen as T₀=2π/ω₀ which gives the formula

$$\frac{T}{{T}_{0}} = 1 - \frac{1}{2} [ \frac{{k}_{3}}{{k}_{1}} - ( \frac{α}{2} - \frac{2}{3} ) ] {θ}^{2} + 0 ( {θ}^{4} ) .$$

This gives an explicit formula for the main term of the circular isochronism defect

$$δ = 1 - \frac{T}{{T}_{0}} = \frac{1}{2} [ \frac{{k}_{3}}{{k}_{1}} - ( \frac{α}{2} - \frac{2}{3} ) ] {θ}^{2} + 0 ( {θ}^{4} ) . \qquad ( 4 )$$

### Minimizing Circular Isochronism Defect by Modifying Body Geometry

The circular isochronism defect has a power series expansion with first term in θ², so cancelling this term will reduce circular isochronism error to the next smaller order, O(θ⁴), so of second order with respect to the main term. Formula (4) shows that this cancellation occurs when the aspect ratio is

$$α = 2 \frac{{k}_{3}}{{k}_{1}} + \frac{4}{3} . \qquad ( 5 )$$

It follows that for any central potential and corresponding restoring torque, there is an explicitly computable aspect ratio for inertia-cylindrical masses which reduces the circular isochronism defect to second order.

### Prismatic Inertial Body Under Linear Restoring Torque

For a linear restoring torque, kₙ=0 for n>1, and equation (5) shows that the circular isotropy defect vanishes to first order for any body for which the aspect ratio is α=4/3.

FIG. 2 illustrates a cylindrical body of height H and radius R, undergoing a linear restoring torque τ=k₁θ. Since the geometric definition of the aspect ratio gives

$$α = \frac{6}{3 + {( \frac{H}{R} )}^{2}} ,$$

it follows that

$$\frac{H}{R} = \sqrt{\frac{3}{2}}$$

leads to zero circular isochronism defect, to first order, for a cylindrical body under linear restoring torque.

More generally, consider a prismatic inertia-cylindrical body, by which we mean a body of constant cross-section having I_{y}=I_{z}, of height H and radius of gyration ρ (ρ=\sqrt{J/m}), again with linear restoring torque τ=k₁θ. The computation for a cylinder works exactly as before, and noting that for a cylinder ρ=R/\sqrt{2}, this shows that

$$\frac{H}{ρ} = \sqrt{3}$$

leads to zero circular isochronism defect, up to first order.

### Tuning Isochronism and Frequency

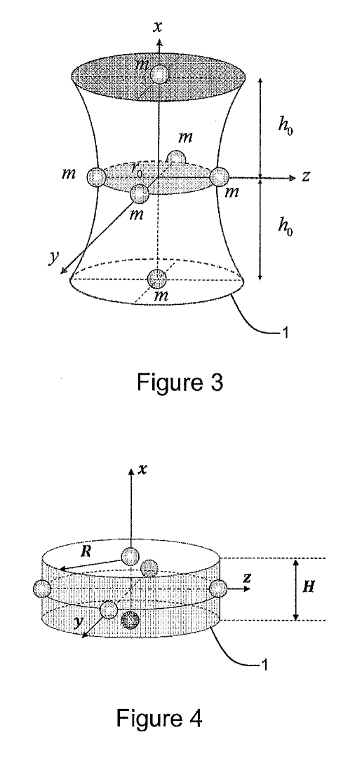

An inertia-cylindrical inertial body 1 will now be described with tunable inertias, in connection with FIG. 3. Additional bodies are positioned on the inertia-cylindrical body in analogy to the tuning screws used for fine-tuning the frequency of a classical watch balance wheel. Bodies referred to here as equatorial tuning bodies, or equatorial inertial blocks are distributed on the equatorial plane x=0 at distance r₀ from the origin so that their total moment of inertia around y equals their moment of inertia around z, and it is further assumed that they are point masses. FIG. 3 shows the example of four equatorial tuning bodies, each of mass m, distributed symmetrically on the equatorial plane. The analysis here is limited to this case; the general case is similar. Two bodies referred to as polar tuning bodies or polar inertial blocks, each of mass m are located on the polar x axis at x=±h₀. The equatorial bodies displace radially while the polar bodies displace along the polar x axis. It is assumed that that these tuning bodies act as point masses in order eliminate spurious moments of inertia.

As before, the inertia-cylindrical body without tuning bodies has moments of inertia I_{y}=I_{z}=I and Iₓ=J. The moments of inertia of the body with tuning bodies are

Iₘ=I+2m(r₀²+h₀²)

about the y and z axes and

Jₘ=J+4mr₀²

about the x axis. Denoting the displacement of the equatorial tuning bodies by Δr and the displacement of the polar bodies by Δh, the moments of inertia of the main body after tuning will be

Iₜ=Iₘ+4m(r₀Δr+h₀Δh)+2m((Δr)²+(Δh)²)

about the y and z axes and

Iₜ=Jₘ+8mr₀Δr+4m(Δr)²

about the x axis.
Tuning Isochronism without Changing Frequency

In order to tune isochronism without changing frequency, Iₜ should equal to Iₘ so that

2(r₀Δr+h₀Δh)+(Δr)²+(Δh)²=0.

Since the square terms are of second order, one has

$$Δ h = - \frac{{r}_{0}}{{h}_{0}} Δ r , \qquad ( 6 )$$

up to first order. With this relation between the polar and the radial displacements of the tuning bodies, frequency change is negligible but isochronism defect can be tuned. The new aspect ratio is

$${α}_{t} = \frac{{J}_{m} + 8 {mr}_{0} Δ r + 4 {m ( Δ r )}^{2}}{{I}_{m} + 2 {m ( Δ r )}^{2} ( 1 + \frac{{r}_{0}^{2}}{{h}_{0}^{2}} )} = α + \frac{8 {mr}_{0}}{{I}_{m}} Δ r + O ( {( Δ r )}^{2} ) ,$$

where α=Jₘ/Iₘ. The isochronism defect after tuning is

$${δ}_{t} = \frac{1}{2} [ \frac{{k}_{3}}{{k}_{1}} - ( \frac{{α}_{t}}{2} - \frac{2}{3} ) ] {θ}^{2} + O ( {( θΔ r )}^{2} ) + O ( {θ}^{4} ) .$$

Tuning Frequency without Changing Isochronism

In order to tune frequency without changing isochronism, Jₜ/Iₜ should equal Jₘ/Iₘ. This gives

$$Δ h = \frac{{r}_{0}}{{h}_{0}} \frac{2 - α}{α} Δ r , \qquad ( 7 )$$

up to first order. Given this relation between the polar and radial tuning bodies, isochronism stays the same up to first order in Δr and the frequency changes to

$${ω}_{t} = {ω}_{0} \sqrt{\frac{1}{1 + \frac{8 {mr}_{0} Δ r}{{J}_{m}}}} = {ω}_{0} ( 1 - \frac{4 {mr}_{0} Δ r}{{J}_{m}} ) ,$$

up to first order in Δr.

### Example: Tuning a Cylinder Under Linear Restoring Torque

As an example, the fine tuning of a cylindrically-shaped inertial body 1 under linear restoring torque is described in reference to FIG. 4. Equatorial tuning bodies of mass m are distributed symmetrically on the equatorial y-z plane at distance R from the origin. Polar tuning bodies, also of mass m, are located at x=±H/2. Equation (6) gives the relation between ΔR and ΔH required to tune the circular isochronism defect without changing the frequency

$$Δ H = - \frac{2 R}{H} Δ R .$$

The aspect ratio after this tuning is

$${α}_{t} = \frac{4}{3} ( 1 + \frac{16}{\frac{M}{m} + θ} \frac{Δ R}{R} ) + O ( {( Δ R )}^{2} ) ,$$

where M denotes mass of cylinder without tuning bodies. The circular isochronism defect after tuning is

$${δ}_{t} = - \frac{16}{3 ( \frac{M}{m} + 8 )} \frac{Δ R}{R} {θ}^{2} + O ( {( θΔ r )}^{2} ) + O ( {θ}^{4} ) .$$

Similarly, Equation (7) gives the relation between polar and radial displacements of tuning bodies required to tune the frequency without changing the isochronism,

$$Δ H = \frac{R}{H} Δ R .$$

The frequency after tuning is

$${ω}_{t} = {ω}_{0} \sqrt{\frac{1}{1 + \frac{16}{\frac{M}{m} + 8} \frac{Δ R}{R}}} = {ω}_{0} ( 1 - \frac{8}{\frac{M}{m} + 8} \frac{Δ R}{R} ) + O ( {( Δ R )}^{2} ) .$$

### Specific Geometries

### Prismatic Bodies Under Linear Restoring Torque

Above, purely rotational 2 DOF oscillators comprising inertia-cylindrical prismatic bodies under linear restoring torque were described in relation to FIG. 2. It was shown in the corresponding section that the aspect ratio α=4/3 leads to zero circular isochronism up to second order. In this section, the geometric parameter leading to zero circular isochronism will be characterized in terms of the ratio of height to cross-section side length. This parameter will be referred to as the geometric aspect ratio γ.

### Regular Polygonal Prismatic Bodies

Consider a prismatic body of height it and cross-section a regular n-sided polygon of side length a. The geometric aspect ratio leading to circular isochronism up to second order is

$$γ = \frac{H}{a} = \frac{1}{2} \sqrt{\frac{1}{2} ( 3 {cot}^{2} \frac{π}{n} + 1 )} .$$

Special cases for small values of n are given in Table 1 below.

TABLE 1

| n | 3 | 4 | 5 | 6 |
|---|---|---|---|---|
| γ | ½ | $\frac{\sqrt{2}}{2}$ | $\frac{1}{2} \sqrt{\frac{10 + 3 \sqrt{5}}{5}}$ | $\frac{\sqrt{5}}{2}$ |

### Cylindrical Prismatic Body

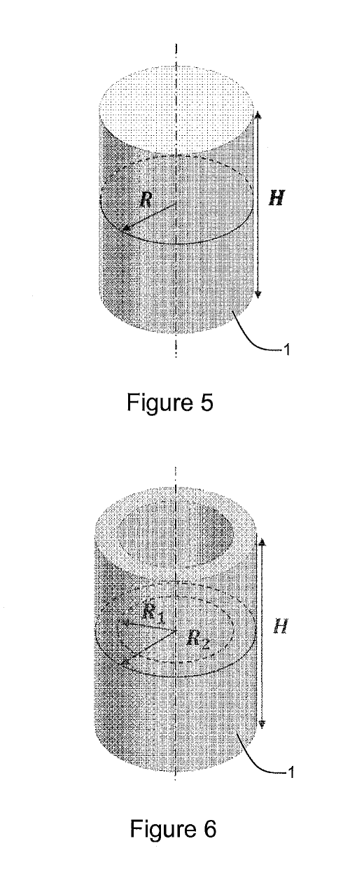

FIG. 5 illustrates a cylindrical prismatic inertial body 1 of height H and cross-section radius R. As shown above, circular isochronism defect vanishes up to second order when

$$\frac{H}{R} = \sqrt{\frac{3}{2}} .$$

FIG. 6 illustrates a hollow cylindrical prismatic body of height H and cross-section an annulus of inner radius R₁ and outer radius R₂. The dimensions leading to circular isochronism up to second order are

$$\frac{H}{{R}_{2}} = \sqrt{\frac{3}{2} [ 1 + {( \frac{{R}_{1}}{{R}_{2}} )}^{2} ]} .$$

### General Prismatic Body

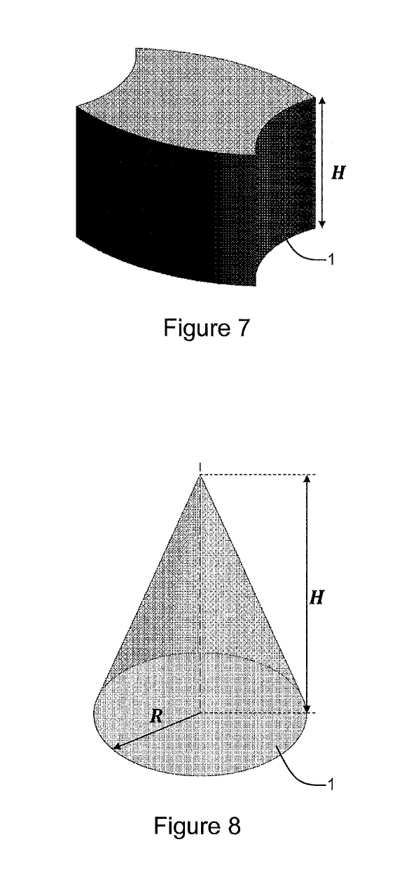

FIG. 7 illustrates a general prismatic inertia-cylindrical inertial body 1 of height H and constant cross-section, with radius of gyration ρ=\sqrt{J/m}, the dimensions leading to circular isochronism up to second order are

$$\frac{H}{ρ} = \sqrt{3} .$$

### Pyramidal Bodies Under Linear Restoring Torque

In the following sections, purely rotational 2-DOF oscillators comprising of inertia-cylindrical pyramidal inertial bodies 1 under linear restoring torque are described. It is assumed that the center of rotation coincides with the center of mass.

### Regular Polygonal Pyramidal Bodies

Consider a general polygonal pyramidal inertial body 1 of height H and base a regular n-sided polygon with side length a, and once again denote by γ=H/a the geometric aspect ratio. The geometric aspect ratio leading to circular isochronism up to second order is

$$γ = \sqrt{\frac{1 + 3 {cot}^{2} \frac{π}{n}}{6}} .$$

Table 2 gives specific values for small values of.

TABLE 2

| n | 3 | 4 | 5 | 6 |
|---|---|---|---|---|
| γ | $\frac{\sqrt{3}}{3}$ | $\frac{\sqrt{6}}{3}$ | $\sqrt{\frac{2}{3} + \frac{\sqrt{5}}{5}}$ | $\frac{\sqrt{15}}{3}$ |

### Conical Body

FIG. 8 shows a conical inertial body 1 of height H and base of radius R. The dimensions leading to circular isochronism up to second order are

$$\frac{H}{R} = \sqrt{2} .$$

### General Pyramidal Body

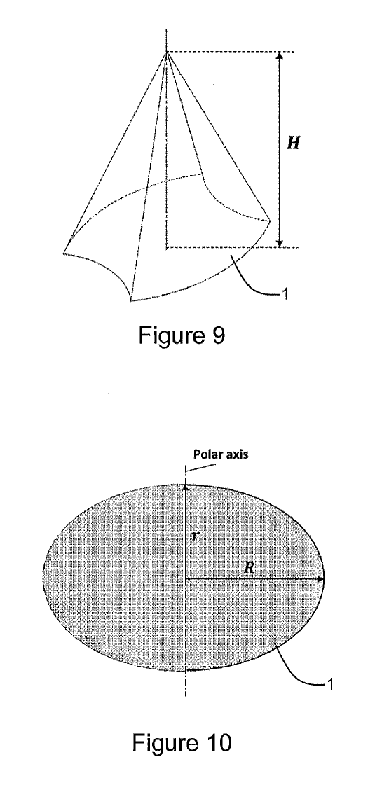

FIG. 9 illustrates a general pyramidal inertia-cylindrical inertial body 1 of height H and base having radius of gyration ρ=\sqrt{J_{A}/A}, where J_{A} is the polar area moment of inertia of the base and A is the area of the base. The dimensions leading to circular isochronism up to second order are

$$\frac{H}{ρ} = 2.$$

### Bodies of Revolution Under Linear Restoring Torque

Below are described purely rotational 2-DOF oscillators formed as bodies of revolution and give dimensions leading to zero circular isochronism up to second order.

### Ellipsoid

FIG. 10 illustrates an inertial body 1 shaped as an ellipsoid with semi-major axis R and semi-minor axis r about the polar axis formed by revolution of a semi ellipse. The dimensions leading to circular isochronism up to second order are

$$\frac{r}{R} = \frac{\sqrt{2}}{2} .$$

### Hollow Ellipsoid

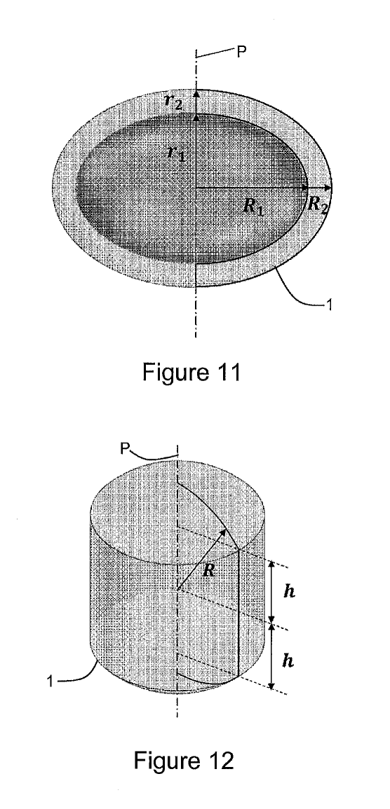

FIG. 11 illustrates an inertial body 1 shaped as a hollow ellipsoid formed by revolution of the area between two semi ellipses about the polar axis P. The semi-major and semi-minor axes are R₂ and r₂ for outer ellipse and R₁ and r₁ for inner ellipse. The dimensions leading to circular isochronism up to second order is

$$\frac{{r}_{2}}{{R}_{2}} = \sqrt{\frac{1 - \frac{{r}_{1}}{{r}_{2}} {( \frac{{R}_{1}}{{R}_{2}} )}^{4}}{2 [ 1 - {( \frac{{R}_{1}}{{R}_{2}} )}^{2} {( \frac{{r}_{1}}{{r}_{2}} )}^{3} ]} .}$$

### Sphere Cut by a Cylinder

FIG. 12 illustrates an inertial body 1 comprising a body of revolution formed by a sphere of radius R cut by a cylinder of height 2h. The dimensions leading to circular isochronism up to second order satisfy

$$64 {( \frac{R}{h} )}^{3} - 22 {( \frac{R}{h} )}^{2} - 108 ( \frac{R}{h} ) - 54 = 0 ,$$

which has the unique real root

$$\frac{R}{h} \approx 1.6633 .$$

### Bodies of Revolution of Circular Arcs

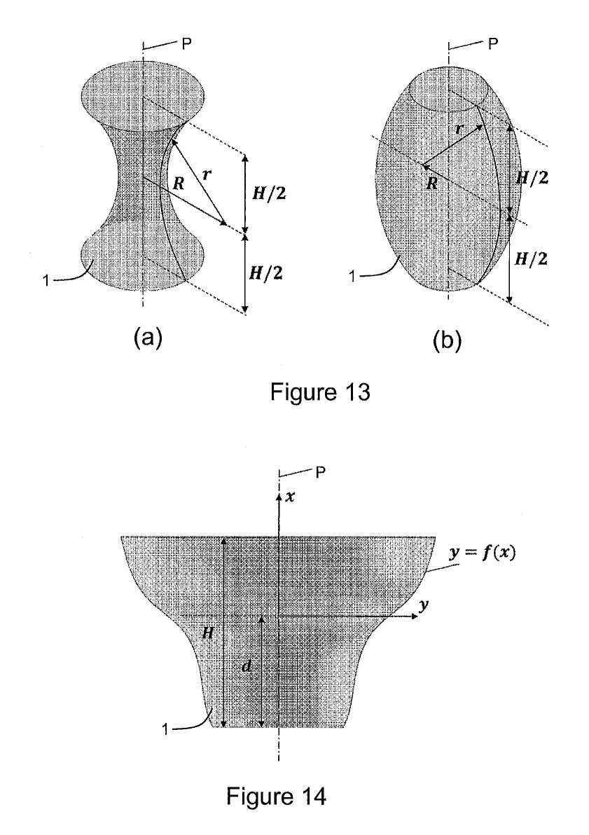

FIG. 13 illustrates two variants of inertial bodies 1 formed as bodies of revolution of circular arcs of radius r about the polar axis, that of FIG. 13 (a) being concave, and that of FIG. 13 (b) being convex. The distance of center of the arc from the polar axis is R and the height of the body is H. The dimensions leading to circular isochronism up to second order satisfy

$$\frac{{\int }_{0}^{H / 2} {( R - \sqrt{{r}^{2} - {x}^{2}} )}^{4} dx}{{\int }_{0}^{H / 2} {( R - \sqrt{{r}^{2} - {x}^{2}} )}^{2} [ \frac{1}{4} {( R - \sqrt{{r}^{2} - {x}^{2}} )}^{2} + {x}^{2} ] dx} = \frac{8}{3} ,$$

where the left hand side can be expressed in terms of elementary functions.

### General Bodies of Revolution

FIG. 14 illustrates an inertial body 1 shaped as a body of revolution formed by a general curve y=f(x) about the polar axis. N is the height and d is the distance of the center of mass from the bottom surface. The dimensions leading to circular isochronism up to second order satisfy

$$\frac{{\int }_{- d}^{H - d} {f ( x )}^{4} dx}{{\int }_{- d}^{H - d} {f ( x )}^{2} [ \frac{1}{4} {f ( x )}^{2} + {x}^{2} ] dx} = \frac{8}{3} .$$

### Mechanisms for Fine-Tuning Isochronism and Frequency

Below, systems for fine-tuning moments of inertia are described. These allows fine-tuning of isochronism and frequency of purely rotational 2-DOF oscillators according to the invention.

### Five Screw Mechanism

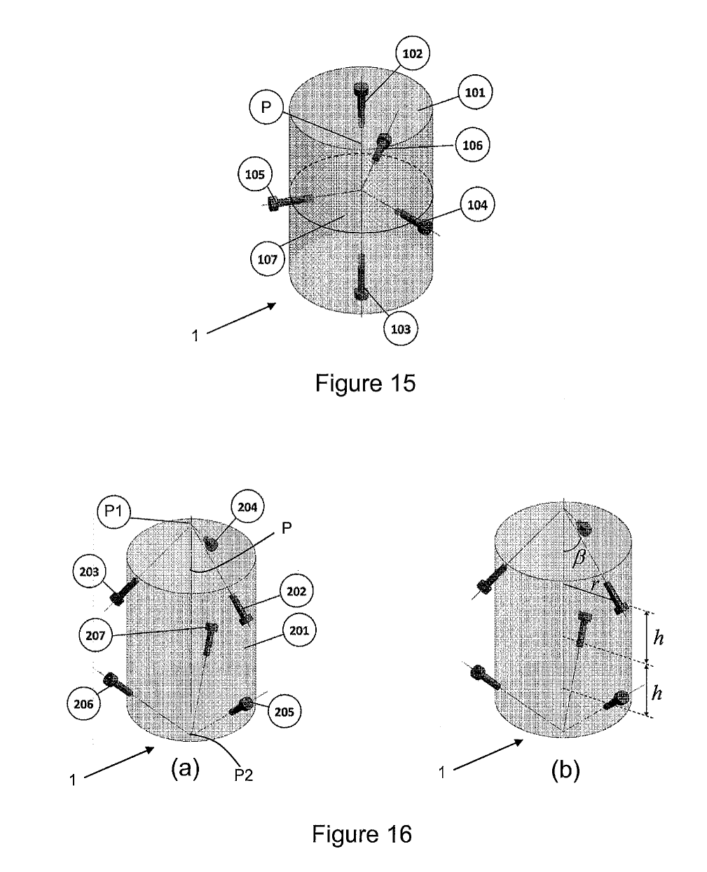

FIG. 15 illustrates an inertial body 1 comprising a cylindrical mass 101 (which may alternatively have any other convenient form) and five screws 102-106 serving as inertial blocks which are attached to the purely rotational 2-DOF mass 101. Two substantially identical polar screws 102 and 103, serving as polar inertial blocks, are located extending along the polar axis 108 of the mass 101 and three substantially identical equatorial screws 104-106, serving as equatorial inertial blocks, are evenly distributed on the equatorial plane 107 of the oscillator, extending radially. The polar screws displace along the polar axis P and the equatorial screws displace radially along three axes lying on the equatorial plane 107, passing through the inertial body's center of mass, and each at a 120-degree angular shift.

The polar screws 102, 103 and the equatorial screws 104-106 can move independently. Displacing the polar 102, 103 and equatorial screws 104-106 allows fine-tuning of isochronism and frequency as described above by selectively varying the primary moment of inertia I and the secondary moment of inertia J.

Note that N>3 evenly distributed substantially identical equatorial screws can also be used in this mechanism, four, five, six, seven or eight being particularly suitable.

### Six Screw Mechanism

FIG. 18 illustrates an alternative arrangement of an inertial body 1 to that of FIG. 15, in which six substantially identical screws 202-207 serving as inertial blocks are attached to the purely rotational 2-DOF oscillator mass 201. Three screws 202-204 are located in the top half of the mass 201 (i.e. on one side of a plane perpendicular to the polar axis P and passing through or near to the center of gravity of the inertial body 1), and are evenly distributed about the polar axis P in a conical formation, each screw 202-204 extending along a respective axis intersecting polar axis P at a first point P1. Another three screws 205-207 are located at the bottom half of the mass 201 (i.e. on the other side of said plane) and are again evenly distributed about the polar axis P in a conical formation, each of these screws 205-207 likewise extending along a respective axis intersecting the polar axis P at a second point P2. In the variant illustrated, the screws are arranged in pairs situated directly one above the other, although they can be offset, notably such that each screw of the upper set 202-204 is equidistant from the nearest two respective screws of the lower set 205-207. Furthermore, as illustrated, points P1 and P2 are situated further from the center of gravity of the inertial body 1 than the planes containing each set of three screws 202-204, 205-207 respectively, however the opposite configuration is also possible, the stems of the screws hence extending towards the plane containing the center of gravity of the inertial body 1 rather than outwards as illustrated.

The center of gravity of the screws 202-207 have distance h from the equatorial plane and distance r from the polar axis of the oscillator, see FIG. 16bb. The axes of screws have the same angle β with the polar axis. In case of tuning isochronism without changing the frequency of oscillations,

$$β = {tan}^{- 1} \frac{r}{2 h}$$

and in case of tuning the frequency of oscillations without changing the isochronism,

$$β = {tan}^{- 1} \frac{( α - 2 ) r}{2 α h} ,$$

where σ=Jₘ/Iₘ in which Jₘ and Iₘ are moments of inertia of the oscillator with screws.

By displacing the screws, one is able to fine-tune the isochronism and frequency by selectively varying the primary moment of inertia I and the secondary moment of inertia J. This mechanism also works with N>3 equally distributed substantially identical screws at the top and bottom halves of the oscillator mass.

### Disk Mechanism

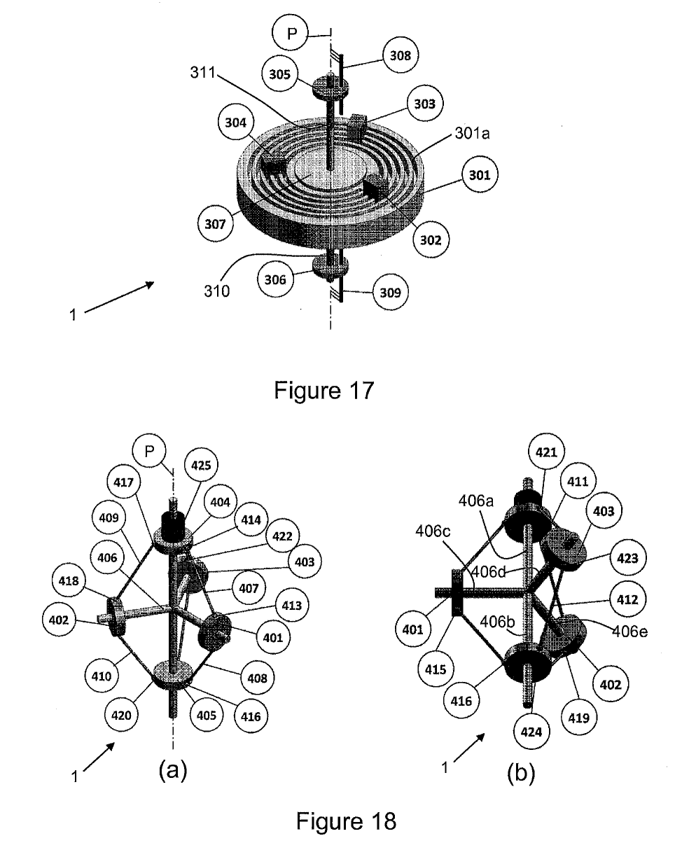

FIG. 17 illustrates an inertial body 1 arrangement applying the five inertial block principle discussed above. This variant comprises a disk 301 having an axis lying on polar axis P and supporting three substantially identical equatorial inertial blocks 302-304 located on the equatorial plane of the oscillator mass and equally distributed about the polar axis P. The arrangement further comprises two nuts 305 and 306, serving as polar inertial blocks, located on the polar axis P. Furthermore, two guiding rods 308 and 309 are provided, each passing through corresponding eccentric holes in each respective nut 305, 306 and being attached to a fixed frame element (not illustrated) to prevent nuts 305 and 306 from rotating about the polar axis P. The disk 301 comprises a hub 307 which supports two at least partially-threaded rods 310, 311 which extend from said hub 307 in opposite directions along the polar axis P. These rods 310, 311 may be made as a single piece. The above-mentioned nuts 305 and 306 are mounted on the threaded rods 310, 311 so that when the hub 307 rotates with respect to the disk 301, the nuts 305, 306 displace along the threaded rods 310, 311, and hence along the polar axis P, modifying the secondary moment of inertia J.

The disk 301 furthermore comprises a spiral groove 301a, into which fit wedges provided on the equatorial blocks 302-304 so that when equatorial blocks 302-304 are moved along the spiral groove 301a, e.g. by rotating the disk relative to the equatorial blocks 302-304, these latter displace radially so as to vary the primary moment of inertia I. The relative position of the equatorial blocks 302-304 can also be varied in order to tune the position of the center of gravity of the inertial body 1 such that it lies on polar axis P.

The hub 307 can be attached to the disk 301, or can be rotationally decoupled therefrom so as to be able to rotate with respect thereto: when attached, the polar displacement of nuts 305 and 306 is coupled to the radial displacement of blocks 302-304, and when rotationally decoupled, the polar displacement of nuts 305 and 306 is independent of the radial displacement of blocks 302-304. The isochronism and frequency can thus be tuned by rotating the disk 301 and/or the hub 307 (this latter in the case of the hub being rotationally decoupled from the disk 301). This arrangement also works with N>3 evenly distributed substantially identical equatorial blocks 302-304, Ideally four, five or six blocks.

### Five Mass Mechanism

FIG. 18 illustrates an inertial body 1 comprising five masses 401-405, acting as inertial blocks, supported by a set of first rods 406, upon which the masses 401-405 can slide. This set of first rods 406 comprises a pair of polar rods 406a, 406b extending along the polar axis P and which each carry a respective polar mass 404, 405 serving as a polar inertial block. Set of first rods 406 also comprises three equatorial rods 406c, 406d, 406e which are equally spaced radially and meet at the junction of the first pair of rods 406a, 406b. Said three equatorial rods 406c, 406d, 406e each support a respective equatorial mass 401, 402, 403, likewise serving as an equatorial inertial block. Said first pair of rods 406a, 406b, and optionally also the totality of the set of first rods 406 or any subdivision thereof, may formed be a single piece.

Six oblique rods 407-412 are also provided, each joining an equatorial mass 401-403 to an adjacent polar mass 404-405, each equatorial mass 401-403 being hence joined to each polar mass 404, 405.

At the end of each oblique rod 407-412 is situated a ball joint 413-424 connecting each oblique rod 407-412 to a mass 401-405. Furthermore, one of said first rods 406a is threaded at its free extremity and carries a nut 425 which interacts with this thread so as to be able to be displaceable along the polar axis P. Equatorial masses 401-403 are evenly angularly distributed on the equatorial plane of the inertial body 1, are substantially identical, and can displace radially by sliding on the three equatorial rods 406c, 406d and 406e. Polar masses 404 and 405 can displace along the polar axis 426 by sliding on the polar rods 406a, 406b. The primary and secondary moments of inertia I and J can be tuned by rotating nut 425 about the rod 406a. Since the equatorial masses 401-403 are coupled to the polar masses 404, 405 by means of the oblique rods 407-412, radial displacement of the equatorial masses 401-403 is coupled to the polar displacement of the polar masses 404 and 405. This arrangement also works with N>3 evenly distributed substantially identical equatorial masses, for instance four, five, six or seven.

### Flexure Mechanism

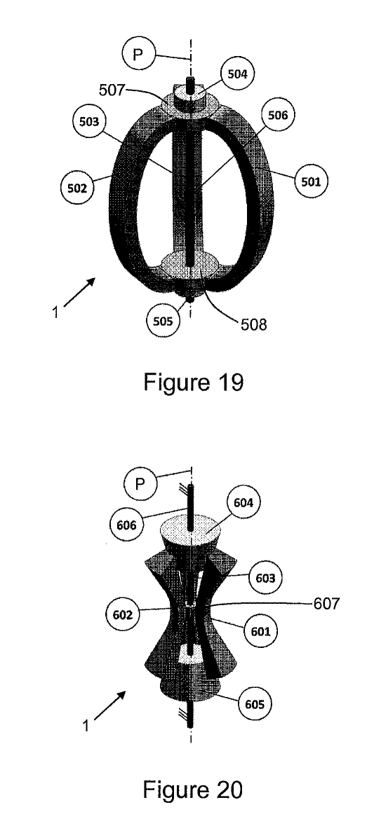

FIG. 19 illustrates an inertial body 1 comprising a rod 506 extending along polar axis P. Mounted upon this rod 506 are three substantially identical flexible elements 501-503 shaped as bars, evenly angularly spaced and joining a first hub 507 to a second hub 508.

Each hub 507, 508 is situated proximate to an extremity of the rod 506. Each of these hubs 507, 508 is slidingly mounted upon the rod 506. The flexible elements 501-503 are arranged so as to tend to straighten themselves, and thus to separate the hubs 507, 508. In order to constrain the flexible elements 501-503 to adopt a desired form, the ends of the rod 506 are threaded, and substantially identical nuts 504 and 505 are situated each contact with a respective hub 507, 508. Displacing the nuts 504, 505 causes the flexible elements to change their form between a longer-and-thinner and a shorter-and-fatter configuration, which modifies the moments of inertia I and J of the inertial body. Furthermore, by moving both nuts 504, 505 in the same direction, the center of gravity of the inertial body 1 can be moved along the rod 506.

Although three flexible elements 501-505 are illustrated here, the arrangement also works with N>3 equally distributed substantially identical flexible elements, for instance four, five, six, seven or even more flexible elements. Furthermore, the flexible elements may be formed in a curved or zigzag configuration, or even as a lattice similar to that used in a medical stent

### Flexure and Wedge Mechanism

FIG. 20 illustrates an inertial body 1 comprising three substantially identical flexible elements 601-603 evenly distributed about polar axis P in an arrangement resembling a collet. Each of these flexible elements 801-603 extends alongside the polar axis P and is attached at its midpoint to a hub 607. Hub 607 is mounted slidingly on rod 606 extending along said polar axis P.

Flexible elements 601-603 are caused to flex outwards, away from the rod 606, by means of two substantially identical conical wedges 604 and 605, mounted movably on the rod 606. Each of these wedges 604, 605 is interposed between the corresponding extremities of the flexible elements 601-603, such that a displacement of one or both wedges 604, 605 towards the hub 607 causes the extremities of the flexible elements 601-603 to splay outwards, or vice-verse, thereby changing the primary and secondary moments of inertia I and J. It should be noted that the extremities of the flexible elements 601-603 can slide on the surface of the wedges 604, 605, such that displacement of one wedge 604, 605 with respect to the other will cause both sets of extremities of the flexible elements 601-603 to splay out, and will cause the center of gravity of the inertial body 1 to displace along the rod 606.

In order to displace the wedges 604, 605, these latter may be threaded onto a threaded section of the rod 606, and may be rotated with respect to the rod 606 by means of an appropriate tool. Alternatively, the wedges 604, 605 may be slidingly mounted on the rod 606, and threaded nuts can be provided in analogy to the variant of FIG. 19.

In the illustrated variant, the interior surfaces of the extremities of the flexible elements 601-603 are concave so as to better interface with the outer surface of the wedges 604, 605 for stability, however they may alternatively be straight or convex, or any other convenient shape. Furthermore, it should be noted that the inertial body 1 may comprise N>3 equally distributed substantially identical flexible elements 601-603, for instance four, five, six, seven or even more.

### Application in a Mechanical Oscillator

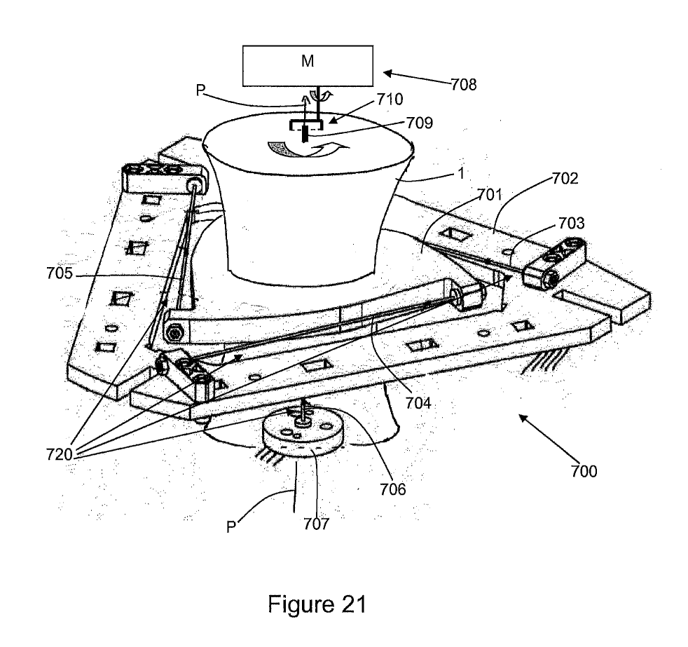

FIG. 21 illustrates a variant of a mechanical oscillator 700 comprising an inertial body 1 of any type as described above, or of any other convenient type fulfilling the conditions of the invention. In the illustration, inertial body 1 is of the generalized type as illustrated in FIG. 1.

Inertial body 1 is mounted in a hub 701 which serves as a support therefor. Hub 701 is connected to a frame 702 by means of an elastic system 720 comprising three flexures 703-705 situated in a co-planar manner and evenly angularly spaced around the inertial body 1 in a plane perpendicular to the polar axis P of the inertial body 1 when it is at rest. Each of said flexures 703-705 is a flexible rod acting in bending. The elastic system also comprises a further flexure 706 is situated along said polar axis P, extending from an anchor 707 which is in a fixed relation to the frame 702, and is attached to the inertial body 1 at a point situated on said polar axis P when said inertial body 1 is at rest. The inertial body 1 is partially transparent in FIG. 21 in order to show this feature.

This arrangement corresponds largely to that of FIGS. 31-33 of WO2015104693, herein incorporated by reference in its entirety, and hence need not be described further. Alternatively, any other convenient 2-DOF elastic system can also be used.

In order to drive the inertial body in 2-DOF oscillatory motion, any convenient drive mechanism 708 may be provided. In the illustrated variant, drive mechanism 708 comprises a motor M of any convenient type (e.g. electric or mechanical), powered by a source of energy (e.g. a battery or a spring, as appropriate). This motor drives the 2-DOF orbital motion of the inertial body 1 by means of a sliding crank arrangement 710, similar to that described in WO2015104693, which interacts with a pin 709 provided on the upper surface of the inertial body 1, coaxial with the polar axis P when the inertial body 1 is at rest. Alternatively, pin 709 may be offset, or any other convenient arrangement for driving may be used.

Although the invention has been described in connection with specific embodiments, variations thereto are possible without departing from the scope of the invention as defined in the appended claims.

1-19. (canceled)

20. Mechanical oscillator comprising:
an inertial body having a primary moment of inertia I about a first (y) and second (z) orthogonal axes, and a secondary moment of inertia J about a third axis (x, P) orthogonal to each of said first (y) and second (z) axes; and
an elastic system arranged to apply a restoring torque T to said inertial body, said restoring torque T acting to urge said inertial body towards a resting position, said elastic system being arranged such that said inertial body has substantially two degrees of freedom in rotation, one of said degrees of freedom being around said first axis (y) and another of said degrees of freedom being around said second axis (z), and substantially zero degrees of freedom in translation,
wherein the ratio of secondary moment of inertia J to primary moment of inertia/substantially obeys the equation:
$$\frac{J}{I} = \frac{2 {k}_{3}}{{k}_{1}} + 4 / 3$$
and in that said restoring torque τ substantially obeys the equation:
τ(θ)=k₁θ+k₃θ³+k₅θ⁵+ . . .
wherein k₁, k₃, k₅ are constants and θ is an angle of inclination of said third axis (x, P) of said inertial body with respect to a direction of said third axis (xᵣ) when said inertial body is in said resting position.

21. Mechanical oscillator according to claim 20, wherein said inertial body is one of: a cylinder; a prism; a pyramid; a cone; a body of revolution.

22. Mechanical oscillator according to claim 20, wherein said elastic system comprises a plurality of elastic articulations.

23. Mechanical oscillator according to claim 20, wherein said inertial body comprises at least five adjustable inertial blocks arranged so as to adjust said primary moment of inertia I and said secondary moment of inertia J.

24. Mechanical oscillator according to claim 23, wherein two of said adjustable inertial blocks are situated along said third axis (x) and are adjustable along said third axis (x), and wherein at least three of said adjustable inertial blocks are evenly angularly spaced around said inertial body and are situated in a plane parallel to said first axis (y) and to said second axis (z), these latter adjustable inertial blocks being adjustable radially with respect to said inertial body.

25. Mechanical oscillator according to claim 23, wherein said adjustable inertial blocks are arranged as a first set of inertial blocks arranged in a first half of said inertial body situated on a first side of a plane perpendicular to said third axis and a second set of inertial blocks arranged in a second half of said inertial body situated on another side of said plane, wherein each of said sets of inertial blocks comprises at least three inertial blocks distributed evenly around said third axis (x, P) in a conical configuration, each inertial body being displaceable along a respective axis intersecting said third axis (x, P).

26. Mechanical oscillator according to claim 25, wherein the axes of displacement of the inertial blocks said first set intersect said third axis (x, P) at a first point situated further from the center of gravity of the inertial body than a plane comprising said first set of inertial blocks, and wherein the axes of displacement of the inertial blocks of said second set intersect said third axis (x, P) at a second point situated further from the center of gravity of the inertial body than a plane comprising said second set of inertial blocks.

27. Mechanical oscillator according to claim 23, wherein at least some of said inertial blocks are screws.

28. Mechanical oscillator according to claim 23, wherein said inertial body comprises a disk, wherein said disk is mounted on at least one rod extending along said third axis (x, P), said disk supporting at least three equatorial inertial blocks and said rod supports a pair of polar inertial blocks, one of said polar inertial blocks being situated on each side of said disk.

29. Mechanical oscillator according to claim 28, wherein said disk comprises a spiral groove supporting said at least three equatorial inertial blocks.

30. Mechanical oscillator according to claim 20, wherein said inertial body comprises a set of first rods comprising at least one polar rod extending along said third axis (x, P), and at least three equatorial rods extending from said at least one polar rod in a plane perpendicular to said third axis (x, P), said at least one polar rod supporting a pair of polar inertial blocks, one situated on each side of said plane, and each of said equatorial rods supporting an equatorial inertial block, at least some of said inertial blocks being movably mounted upon their respective rods.

31. Mechanical oscillator according to claim 30, wherein each equatorial inertial block is linked to each polar inertial block by means of an oblique rod.

32. Mechanical oscillator according to claim 31, wherein each oblique rod is joined to its respective inertial blocks by means of a ball joint.

33. Mechanical oscillator according to claim 20, wherein said inertial body comprises at least three elastically deformable elements.

34. Mechanical oscillator according to claim 33, wherein said inertial body comprises a rod situated along said third axis (x, P), said at least three elastically deformable elements being evenly distributed around said third axis (x, P) and joined together at each extremity, said extremities being displaceable so as to vary the form of said elastically deformable elements.

35. Mechanical oscillator according to claim 34, wherein the extremities of said elastically deformable elements are displaceable substantially parallel to the rod or away from the rod.

36. Mechanical oscillator according to claim 35, wherein the extremities of said elastically deformable elements are displaceable along said rod by means of at least one nut provided on said rod.

37. Mechanical oscillator according to claim 35, wherein said elastically deformable elements are slidably attached to said rod at an intermediate point of said elastically deformable elements, and wherein the extremities of said elastically deformable elements are displaceable away from the rod by means of a pair of wedges interposed between said elastically deformable elements, one wedge being situated proximate to each end thereof.

38. Mechanical oscillator comprising:
an inertial body having a primary moment of inertia I about a first (y) and second (z) orthogonal axes, and a secondary moment of inertia J about a third axis (x, P) orthogonal to each of said first and second axes; and
an elastic system arranged to apply a restoring torque T to said inertial body, said elastic system being arranged such that said inertial body has substantially two degrees of freedom in rotation, one of said degrees of freedom being around said first axis (y) and another of said degrees of freedom being around said second axis (z), and substantially zero degrees of freedom in translation,
wherein the ratio of secondary moment of inertia J to primary moment of inertia/substantially obeys the equation:
$$\frac{J}{I} = 4 / 3$$
and in that said restoring torque z substantially obeys the equation:
τ(θ)=k₁θ
wherein k₁ is a constant and θ is an angle of inclination of said third axis (x, P) of said inertial body with respect to a direction of said third axis (xᵣ) when said inertial body is in said resting position.

39. Mechanical oscillator according to claim 38, wherein said inertial body is one of: a cylinder; a prism; a pyramid; a cone; a body of revolution.

40. Mechanical oscillator according to claim 38, wherein said elastic system comprises a plurality of elastic articulations.

41. Mechanical oscillator according to claim 38, wherein said inertial body comprises at least five adjustable inertial blocks arranged so as to adjust said primary moment of inertia I and said secondary moment of inertia J.

42. Mechanical oscillator according to claim 41, wherein two of said adjustable inertial blocks are situated along said third axis (x) and are adjustable along said third axis (x), and wherein at least three of said adjustable inertial blocks are evenly angularly spaced around said inertial body and are situated in a plane parallel to said first axis (y) and to said second axis (z), these latter adjustable inertial blocks being adjustable radially with respect to said inertial body.

43. Mechanical oscillator according to claim 41, wherein said adjustable inertial blocks are arranged as a first set of inertial blocks arranged in a first half of said inertial body situated on a first side of a plane perpendicular to said third axis and a second set of inertial blocks arranged in a second half of said inertial body situated on another side of said plane, wherein each of said sets of inertial blocks comprises at least three inertial blocks distributed evenly around said third axis (x, P) in a conical configuration, each inertial body being displaceable along a respective axis intersecting said third axis (x, P).

44. Mechanical oscillator according to claim 43, wherein the axes of displacement of the inertial blocks said first set intersect said third axis (x, P) at a first point situated further from the center of gravity of the inertial body than a plane comprising said first set of inertial blocks, and wherein the axes of displacement of the inertial blocks of said second set intersect said third axis (x, P) at a second point situated further from the center of gravity of the inertial body than a plane comprising said second set of inertial blocks.

45. Mechanical oscillator according to claim 41, wherein at least some of said inertial blocks are screws.

46. Mechanical oscillator according to claim 41, wherein said inertial body comprises a disk, wherein said disk is mounted on at least one rod extending along said third axis (x, P), said disk supporting at least three equatorial inertial blocks and said rod supports a pair of polar inertial blocks, one of said polar inertial blocks being situated on each side of said disk.

47. Mechanical oscillator according to claim 46, wherein said disk comprises a spiral groove supporting said at least three equatorial inertial blocks.

48. Mechanical oscillator according to claim 38, wherein said inertial body comprises a set of first rods comprising at least one polar rod extending along said third axis (x, P), and at least three equatorial rods extending from said at least one polar rod in a plane perpendicular to said third axis (x, P), said at least one polar rod supporting a pair of polar inertial blocks, one situated on each side of said plane, and each of said equatorial rods supporting an equatorial inertial block, at least some of said inertial blocks being movably mounted upon their respective rods.

49. Mechanical oscillator according to claim 48, wherein each equatorial inertial block is linked to each polar inertial block by means of an oblique rod.

50. Mechanical oscillator according to claim 49, wherein each oblique rod is joined to its respective inertial blocks by means of a ball joint.

51. Mechanical oscillator according to claim 38, wherein said inertial body comprises at least three elastically deformable elements.

52. Mechanical oscillator according to claim 51, wherein said inertial body comprises a rod situated along said third axis (x, P), said at least three elastically deformable elements being evenly distributed around said third axis (x, P) and joined together at each extremity, said extremities being displaceable so as to vary the form of said elastically deformable elements.

53. Mechanical oscillator according to claim 52, wherein the extremities of said elastically deformable elements are displaceable substantially parallel to the rod or away from the rod.

54. Mechanical oscillator according to claim 53, wherein the extremities of said elastically deformable elements are displaceable along said rod by means of at least one nut provided on said rod.

55. Mechanical oscillator according to claim 53, wherein said elastically deformable elements are slidably attached to said rod at an intermediate point of said elastically deformable elements, and wherein the extremities of said elastically deformable elements are displaceable away from the rod by means of a pair of wedges interposed between said elastically deformable elements, one wedge being situated proximate to each end thereof.
